(19) United States
(12) Patent Application Publication
(10) Pub. No.: US 2019/0384996 A1
(43) Pub. Date: Dec. 19, 2019

(54) STYLUS PEN, ELECTRONIC DEVICE, AND DIGITAL COPY GENERATING METHOD

(71) Applicant: SAMSUNG ELECTRONICS CO., LTD., Suwon-si (KR)

(72) Inventors: Sang Yun Park, Hwaseong-si (KR); Jae Min Kang, Seoul (KR)

(73) Assignee: SAMSUNG ELECTRONICS CO., LTD., Suwon-si (KR)

(21) Appl. No.: 16/442,760

(22) Filed: Jun. 17, 2019

(30) Foreign Application Priority Data
Jun. 19, 2018 (KR) 10-2018-0070490

(51) Int. Cl. G06K 9/22; G06K 9/00; G06F 3/0354; G06F 3/03

(52) U.S. Cl. CPC G06K 9/222; G06F 3/0321; G06F 3/03545; G06K 9/00416

(57) ABSTRACT

A stylus pen, an electronic device, and a digital copy generating method are provided. The electronic device includes a touch screen, and a processor configured to determine whether a paper is placed on the touch screen, and based on the paper being determined to be placed on the touch screen, execute an application, and based on letters or characters being written on the paper or a picture being drawn on the paper, using a stylus pen including a material enabling analog writing, generate a digital copy of the letters, the characters or the picture.

### CROSS-REFERENCE TO RELATED APPLICATION

This application claims priority from Korean Patent Application No. 10-2018-0070490, filed on Jun. 19, 2018, in the Korean Intellectual Property Office, the disclosure of which is incorporated herein by reference in its entirety.

### BACKGROUND

### 1. Field

Apparatuses and methods consistent with embodiments relate to a stylus pen that can also be used as an analog writing tool as well as a digital writing tool, and a digital copy generating method using the same.

### 2. Description of the Related Art

Recently, portable terminals, such as a mobile phone, a personal digital assistant (PDA), a Portable Multimedia Player (PMP), an MP3 player, and the like, are becoming smaller in size for easy portability. With the miniaturization of the portable terminals, a touch screen input type is employed as a type of a key button input of the portable terminal, so that users may input or select information more conveniently. Such touch screen input type enables users to directly input or select information by interfacing with a computer through a screen, in which when a user's hand or an object comes into contact with a position of the touch screen, coordinates of the contact position are detected; and then software performs a function corresponding to the coordinates of the contact position. Accordingly, the touch screen provides functions as both an information display part and an input part.

A stylus pen is used as an input means of the touch screen, but the stylus pen cannot be used for analog writing, causing inconvenience of carrying an analog writing tool separately.

### SUMMARY

According to embodiments, there is provided a stylus pen including a main body, and a tip disposed on the main body, and including a material enabling analog writing.

The tip may include either one or both of a metal-oxide alloy and a graphite-containing polymer.

The tip may have different colors to indicate a replacement time of the tip.

The tip may be divided into a first portion of a first color and a second portion of a second color, and the second portion may be worn out after the first portion is worn out.

The main body may include a tip storage for storing another tip.

According to embodiments, there is provided an electronic device including a touch screen, and a processor configured to determine whether a paper is placed on the touch screen, and based on the paper being determined to be placed on the touch screen, execute an application, and based on letters or characters being written on the paper or a picture being drawn on the paper, using a stylus pen including a material enabling analog writing, generate a digital copy of the letters, the characters or the picture.

The touch screen may be of any one or any combination of an electromagnetic resonance type, an active electrostatic type, a resistive type, and a capacitive type.

The application may be any one or any combination of a note application, a letter tracing application, a drawing application, and a picture tracing application.

The processor may be further configured to, based on an occurrence of an event, generate guide information for the analog writing and for generating the digital copy.

The processor may be further configured to determine whether the paper is placed on a full area or a portion of the touch screen, using either one or both of a camera and a sensor.

The processor may be further configured to adjust a brightness of the touch screen so that any one or any combination of a note line, a word, and a picture that is displayed on the touch screen based on the application being executed, is shown through the paper.

According to embodiments, there is provided a digital copy generating method of an electronic device, the method including determining whether a paper is placed on a touch screen, and based on the paper being determined to be placed on the touch screen, executing an application, and based on words or characters being written on the paper or a picture being drawn on the paper, using a stylus pen including a material enabling analog writing, generating a digital copy of the words, the characters or the picture.

The application may be any one or any combination of a note application, a letter tracing application, a drawing application, and a picture tracing application.

The method may further include, based on an occurrence of an event, generating guide information for the analog writing and for generating the digital copy.

The method may further include determining whether the paper is placed on a full area or a portion of the touch screen, using either one or both of a camera and a sensor.

The method may further include adjusting a brightness of the touch screen so that any one or any combination of a note line, a word, and a picture that is displayed on the touch screen based on the application being executed, is shown through the paper.

### BRIEF DESCRIPTION OF THE DRAWINGS

FIG. 1 is a block diagram illustrating an example of a digital copy generating system.

FIG. 2 is a block diagram illustrating an example of a digital copy generating system implemented as an electromagnetic resonance (EMR) type.

FIG. 3 is a block diagram illustrating an example of a digital copy generating system implemented as an active electrostatic type.

FIG. 4 is a block diagram illustrating an example of a digital copy generating system implemented as a resistive type or a capacitive type.

FIGS. 5, 6 and 7 are diagrams explaining an example of a process of generating a digital copy.

FIG. 8 is a flowchart illustrating an example of a digital copy generating method.

### DETAILED DESCRIPTION

Hereinafter, embodiments of the disclosure will be described in detail with reference to the accompanying drawings. It may be noted that, in the drawings, the same reference symbols refer to same parts, even in different drawings. In the following description, a detailed description of known functions and configurations incorporated herein will be omitted when it may obscure the subject matter of the embodiments.

Process steps described herein may be performed differently from a specified order, unless a specified order is clearly stated in the context of the disclosure. That is, each step may be performed in a specified order, at substantially the same time, or in a reverse order.

Further, the terms used throughout this specification are defined in consideration of the functions according to embodiments, and can be varied according to a purpose of a user or manager, or precedent and so on. Therefore, definitions of the terms may be made on the basis of the overall context.

It will be understood that, although the terms first, second, etc. may be used herein to describe various elements, these elements may not be limited by these terms. These terms are only used to distinguish one element from another. Any references to singular may include plural unless expressly stated otherwise. In the present specification, it may be understood that the terms, such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Further, components that will be described in the specification are discriminated according to functions mainly performed by the components. That is, two or more components that will be described later can be integrated into a single component. Furthermore, a single component that will be explained later can be separated into two or more components. Moreover, each component that will be described can additionally perform some or all of a function executed by another component in addition to the main function thereof. Some or all of the main function of each component that will be explained can be carried out by another component. Each component may be implemented as hardware, software, or a combination of both.

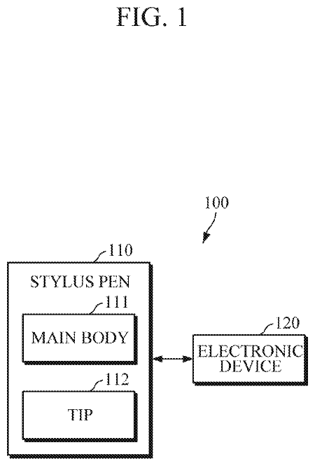

FIG. 1 is a block diagram illustrating an example of a digital copy generating system.

Referring to FIG. 1, the digital copy generating system 100 includes a stylus pen 110 and an electronic device 120.

The stylus pen 110 is a device that may input data to the electronic device 120 by directly or indirectly touching the screen of the electronic device 120, and may be variously referred to as an electronic pen, a touch pen, a stylus, a smart pen, and the like.

The electronic device 120 may be a device that may perform various functions by receiving touch-based inputs. In one embodiment, examples of the electronic device 120 may include a smartphone, a tablet PC, a cellular phone, a video phone, an e-book reader, a desktop computer, a laptop computer, a netbook computer, a workstation, a server, a personal digital assistant (PDA), a portable multimedia player (PMP), an MP3 player, a medical device, a camera, a television (TV), a digital video disk (DVD) player, audio equipment, a refrigerator, an air conditioner, a vacuum cleaner, an oven, a microwave oven, a washing machine, an air cleaner, a set-top box, an electronic dictionary, an electronic key, a camcorder, and an electronic frame, various medical equipment, a wearable device, and the like. Examples of the wearable device may include a wristwatch-type wearable device, a wristband-type wearable device, a ring-type wearable device, a waist belt-type wearable device, a necklace-type wearable device, an ankle band-type wearable device, a thigh band-type wearable device, a forearm band-type wearable device, an eyeglasses-type wearable device, a head-mounted device (HMD), and the like. However, the electronic device is not limited to the above examples, and the wearable device is neither limited thereto.

The stylus pen 110 and the electronic device 120 may be implemented as any one or any combination of an electromagnetic resonance (EMR) type, an active electrostatic type, a resistive type, and a capacitive type.

The stylus pen 110 of the EMR type operates by electromagnetic induction that occurs when a coil embedded in the stylus pen 110 and an electromagnetic field generated by a coil embedded in the electronic device 120 move relative to one another. In the EMR type, the electronic device 120 supplies power to the stylus pen 110 through the electromagnetic field, such that the stylus pen 110 does not require a separate power source. Further, the stylus pen 110 transmits a signal to the electronic device 120 through the electromagnetic field, and the electronic device 120 receives the signal from the stylus pen 110 through the electromagnetic field, such that the electronic device 120 may determine a position and pen pressure of the stylus pen 110.

The stylus pen 110 of the active electrostatic type operates in such a manner that unlike the EMR type, the stylus pen 110 transmits an electrostatic signal, and the electronic device 120 senses the electrostatic signal transmitted by the stylus pen 110. In the active electrostatic type, the stylus pen 110 is provided with a separate power source to transmit the electrostatic signal.

The stylus pen 110 of the resistive type operates by sensing pressure applied to a touch screen of the electronic device 120; and the stylus pen 110 of the capacitive type operates by using a change in electric signal, and by sensing a change in the magnitude of capacitance of the touch screen of the electronic device 120.

The stylus pen 110 includes a main body 111 and a tip 112, and may be configured to enable both digital writing and analog writing. For example, the stylus pen 110 may be implemented as any one or any combination of the above-described electromagnetic resonance (EMR) type, active electrostatic type, resistive type, and capacitive type, and may input data to the electronic device 120 by directly or indirectly touching the touch screen of the electronic device 120 (digital writing). Further, the tip 112 of the stylus pen 110 may be made of a material for writing letters or characters on paper and the like, so that the stylus pen 110 may be used to write letters or characters on paper and the like by directly touching the paper and the like (analog writing). To this end, the tip 112 may be made of any one or any combination of a metal-oxide alloy, a graphite-containing polymer, and the like.

When a user places paper on the full area or a portion of the touch screen of the electronic device 120, the electronic device 120 may sense the paper and may automatically generate a digital copy. Here, the function of generating the digital copy may refer to a function of generating digital data, which is performed in such a manner that when a user places paper on the touch screen of the electronic device 120 and writes letters or characters or draws pictures on the paper, digital data (hereinafter referred to as a digital copy) of the same letters, characters, or pictures on the paper are generated.

In one embodiment, when a user places paper on the full area or a portion of the touch screen of the electronic device 120, the electronic device 120 may sense the paper and may automatically execute an application (e.g., a note application, a letter tracing application, a drawing application, a picture tracing application, etc.), and may adjust brightness of the touch screen so that any one or any combination of note lines, letters, pictures, and the like displayed on the touch screen may be shown through the paper. Further, when a user writes letters or draws pictures on paper placed on the full area or a portion of the touch screen, the electronic device 120 may generate a digital copy corresponding thereto, and may store the generated digital copy.

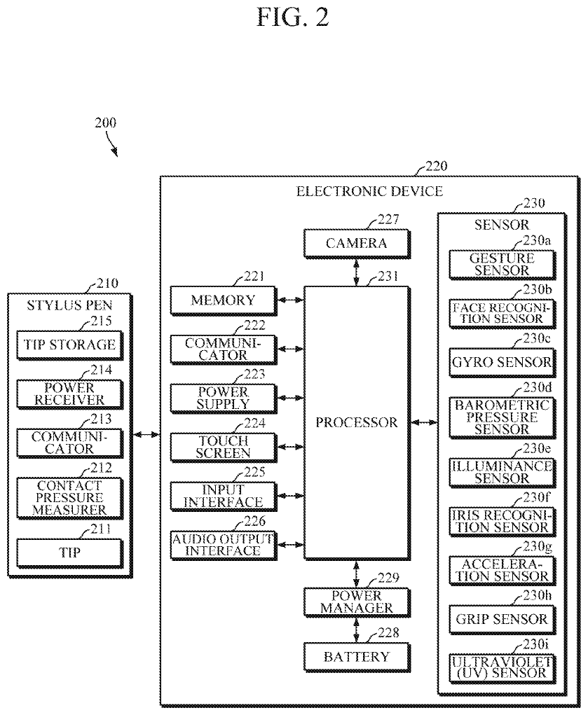

FIG. 2 is a block diagram illustrating an example of a digital copy generating system implemented as an electromagnetic resonance (EMR) type. The digital copy generating system 200 of FIG. 2 may be an example of the digital copy generating system 100 of FIG. 1.

Referring to FIG. 2, the digital copy generating system 200 of an electromagnetic resonance (EMR) type includes a stylus pen 210 and an electronic device 220.

The stylus pen 210 includes a tip 211, a contact pressure measurer 212, a communicator 213, a power receiver 214, a tip storage 215. Here, the contact pressure measurer 212, the communicator 213, the power receiver 214, and the tip storage 215 may be mounted or provided in the main body 111 of FIG. 1.

The tip 211 is a portion that may be come into contact with the electronic device 220, and may protrude from one end of the stylus pen 210. The tip 211 may be called the nib of a pen and the like.

The tip 211 may be made of a material enabling analog writing. In one embodiment, examples of the material enabling analog writing may include any one or any combination of a metal-oxide alloy, a graphite-containing polymer, and the like.

The tip 211 may be formed in partially different colors to indicate a replacement time of the tip 211. In this case, the tip 211 formed in partially different colors indicates not only a case in which the tip 211 is divided into at least two portions, each of which has visually different colors, but also a case in which at least two portions visually have the same color, but letters or characters are written on paper in different colors due to friction between each of the portions of the tip 211 and paper, and the like. In one embodiment, the tip 211 is divided into a first portion and a second portion, which may be formed in layers such that the second portion is worn out after the first portion is worn out.

That is, in one embodiment, as the tip 211 is formed of at least two portions in different colors, a user may recognize a replacement time of the tip 211 by checking a change in color of the tip 211.

The contact pressure measurer 212 may measure pressure applied to the tip 211. For example, the contact pressure measurer 212 may measure contact pressure between the tip 211 and the electronic device 220. To this end, the tip 211 may be connected to the contact pressure measurer 212 to transmit the pressure, applied to the tip 211, to the contact pressure measurer 212. For example, the contact pressure measurer 212 may include a piezoelectric sensor.

The communicator 213 may communicate with the electronic device 220 through an electromagnetic field. For example, the communicator 213 may transmit position information or motion information of the stylus pen 210 and pressure information measured by the contact pressure measurer 212 to the electronic device 220 through the electromagnetic field.

The power receiver 214 may receive power from the electronic device 220 by electromagnetic induction through the electromagnetic field. In this manner, the stylus pen 210 of the electromagnetic resonance type receives power for operation of the stylus pen 210 from the electronic device 220, such that there is no need for a separate battery.

The tip storage 215 may store extra tips. The tip 211 may be worn out after use, in which case a user needs to replace the tip 211. Accordingly, the stylus pen 210 includes the tip storage 215 for keeping extra tips for use in replacement of the tip 211, thereby enabling user convenience.

The electronic device 220 includes a memory 221, a communicator 222, a power supply 223, a touch screen 224, an input interface 225, an audio output interface 226, a camera 227, a battery 228, a power manager 229, a sensor 230, and a processor 231.

The memory 221 may store programs or instructions for operation of the electronic device 220, and may store data input to the electronic device 220, data processed by the electronic device 220, data for processing data of the electronic device 220, and the like.

The memory 221 may include an internal memory or an external memory. The memory 221 may include at least one storage medium of a flash memory type memory, a hard disk type memory, a multimedia card micro type memory, a card type memory (e.g., an SD memory, an XD memory, etc.), a Random Access Memory (RAM), a Static Random Access Memory (SRAM), a Read Only Memory (ROM), an Electrically Erasable Programmable Read Only Memory (EEPROM), a Programmable Read Only Memory (PROM), a magnetic memory, a magnetic disk, and an optical disk, and the like. Further, the electronic device 220 may operate an external storage medium, such as web storage and the like, which performs a storage function of the memory 221.

The communicator 222 may communicate with the stylus pen 210 through an electromagnetic field. For example, the communicator 222 may receive, by electromagnetic induction through the electromagnetic field, position information or motion information of the stylus pen 210 and pressure information measured by the contact pressure measurer 212 from the stylus pen 210.

Further, the communicator 222 may communicate with an external device by using various communication techniques such as Bluetooth communication, Bluetooth Low Energy (BLE) communication, Near Field Communication (NFC), WLAN communication, Zigbee communication, Infrared Data Association (IrDA) communication, Wi-Fi Direct (WFD) communication, Ultra-Wideband (UWB) communication, Ant+ communication, WIFI communication, Radio Frequency Identification (RFID) communication, 3G communication, 4G communication, 5G communication, and the like. In this case, the external device may be medical equipment using data used by the electronic device 220, a processing result data of the electronic device 220, or the like, a printer to print out results, or a display to display the results. In addition, the external device may be a digital TV, a desktop computer, a cellular phone, a smartphone, a tablet PC, a laptop computer, a personal digital assistant (PDA), a portable multimedia player (PMP), a navigation, an MP3 player, a digital camera, a wearable device, and the like, but is not limited thereto.

The power supply 223 may supply power to the stylus pen 210 by electromagnetic induction through an electromagnetic field.

The touch screen 224 may display data used by the electronic device 220, the processing result data of the electronic device 220, and the like. Further, the touch screen 224 may receive input of data by direct or indirect touch of the stylus pen 210. In this case, the touch screen 224 may be implemented as the electromagnetic resonance type.

The input interface 225 may receive input of various operation signals from a user. In one embodiment, the input interface 225 may include a keypad, a dome switch, a jog wheel, a jog switch, a hardware (H/W) button, and the like.

The audio output interface 226 may perform bidirectional conversion between voice and electric signals. In one embodiment, the audio output interface 226 may process voice information input or output through a speaker, a receiver, an earphone, a microphone, and the like, which are included in the audio output interface 226.

The camera 227 may capture still and/or moving images. In one embodiment, the camera 227 may include one or more image sensors (e.g., a front sensor or a rear sensor), a lens, an image signal processor (ISP), a flash (e.g., an LED, a xenon lamp, etc.), and the like.

The battery 228 may supply power for operation of the electronic device 220. The battery 228 may include a rechargeable battery and/or a solar battery.

The power manager 229 may manage power of the electronic device 220. In one embodiment, the power manager 229 may include a power management integrated circuit (PMIC), a charger Integrated Circuit (IC), or a battery gauge. In the PMIC, a charging method may include a wired charging method and/or a wireless charging method. The wireless charging method may include a magnetic resonance type, a magnetic induction type, an electromagnetic wave type, or the like, in which the power manager 229 may further include an additional circuit, e.g., a coil loop, a resonance circuit, a rectifier, and the like. The battery gauge may measure a remaining capacity of a battery, a voltage, a current, or a temperature during charging of the battery.

The sensor 230 may measure a physical quantity or may sense an operating state of the electronic device 220, and may convert the measured or sensed information into an electric signal. The sensor 230 may include any one or any combination of a gesture sensor 230a, a face recognition sensor 230b, a gyro sensor 230c, a barometric pressure sensor 230d, an illuminance sensor 230e, an iris recognition sensor 230f, an acceleration sensor 230g, a grip sensor 230h, and an ultraviolet (UV) sensor 230i. However, the sensor 230 is not limited thereto, and may include an E-nose sensor, an electromyogram (EMG) sensor, an electroencephalogram (EEG) sensor, a photoplethysmogram (PPG) sensor, an electrocardiogram (ECG) sensor, an infrared (IR) sensor, a fingerprint sensor, and the like.

The sensor 230 may further include a control circuit to control at least one sensor included therein. In one embodiment, the electronic device 220 may further include a processor, which is configured to control the sensor 230, as part of the processor 231 or as a separate part, such that the electronic device 220 may control the sensor 230 while the processor 231 is in a sleep state.

The processor 231 may control the overall operation of the electronic device 220. The processor 231 may execute an operating system or an application to control a plurality of hardware or software elements connected to the processor 231, and may perform data processing and data operations.

The processor 231 may adjust thickness of lines or dots displayed on the touch screen 224 based on pressure information received through the communicator 222.

In response to occurrence of an event such as a user instruction and the like, the processor 231 may generate guide information for analog writing and for generating a digital copy corresponding to the analog writing by using the stylus pen 210, and may provide the generated guide information to a user through an output device. In this case, the output device may include a visual output device (e.g., touch screen), an acoustic output device (e.g., speaker), a haptic output device (e.g., vibrator), and the like. In one embodiment, the guide information may include information for guiding writing letters or characters or drawing pictures on paper placed on the touch screen 224 by using the stylus pen 210.

In one embodiment, once a user places paper on the full area or a portion of the touch screen 224, the processor 231 may sense the paper, and may automatically execute an application (e.g., a note application, a letter tracing application, a drawing application, a picture tracing application, etc.). For example, the processor 231 may determine whether the paper is placed on the full area or a portion of the touch screen 224 by using the camera 227 and/or the sensor 230 (e.g., the gesture sensor 230a, the illuminance sensor 230e, etc.), and upon determining that the paper is placed on the full area or a portion of the touch screen 224, the processor 231 may automatically execute an application (e.g., a note application, a letter tracing application, a drawing application, a picture tracing application, etc.). Further, the processor 231 may adjust brightness of the touch screen 224 so that any one or any combination of note lines, letters, pictures, and the like displayed on the touch screen 224 may be shown through the paper. In addition, when a user writes letters or characters, or draws pictures on paper placed on the full area or a portion of the touch screen 224 by using the stylus pen 210, the processor 231 may generate a digital copy corresponding to the writing or drawing, and may store the generated digital copy in the memory 221. In this case, the processor 231 may automatically store the generated digital copy, or may store the generated digital copy by sending a confirm message for storing the generated digital copy to a user and receiving an instruction from the user.

Moreover, in one embodiment, in response to a user's instruction or occurrence of an event after a user places paper on the full area or a portion of the touch screen 224, the processor 231 may execute an application (e.g., a note application, a letter tracing application, a drawing application, a picture tracing application, etc.). In this case, the event may include a touch event and the like by a user's touching an area of the touch screen 224.

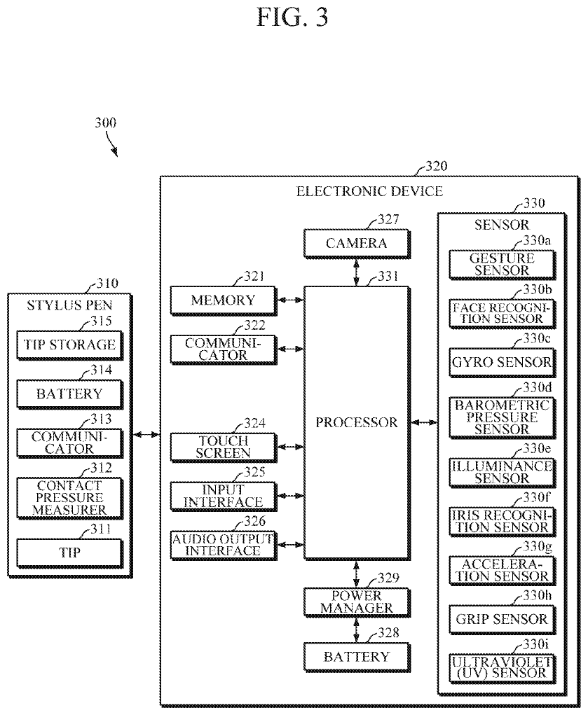

FIG. 3 is a block diagram illustrating an example of a digital copy generating system implemented as an active electrostatic type. The digital copy generating system 300 of FIG. 3 may be an example of the digital copy generating system 100 of FIG. 1.

Referring to FIG. 3, the digital copy generating system of the active electrostatic type includes a stylus pen 310 and an electronic device 320.

The stylus pen 310 includes a tip 311, a contact pressure measurer 312, a communicator 313, a battery 314, and a tip storage 315. Here, the contact pressure measurer 312, the communicator 313, the battery 314, and the tip storage 315 may be mounted or provided in the main body 111 of FIG. 1. The tip 311, the contact pressure measurer 312, and the tip storage 315 are the same as the tip 211, the contact pressure measurer 212, and the tip storage 215 of FIG. 2, such that detailed description thereof will be omitted.

The communicator 313 may communicate with the electronic device 320 through an electrostatic signal. For example, the communicator 313 may transmit pressure information, measured by the contact pressure measurer 312, to the electronic device 220 through the electrostatic signal.

The battery 314 may supply power for operation of the stylus pen 310.

The electronic device 320 includes a memory 321, a communicator 322, a touch screen 324, an input interface 325, an audio output interface 326, a camera 327, a battery 328, a power manager 329, a sensor 330, and a processor 331. Here, the memory 321, the input interface 325, the audio output interface 326, the camera 327, the battery 328, the power manager 329, the sensor 330, and the processor 331 are the same as the memory 221, the input interface 225, the audio output interface 226, the camera 227, the battery 228, the power manager 229, the sensor 230, and the processor 231 of FIG. 2, such that detailed description thereof will be omitted.

The communicator 322 may communicate with the stylus pen 210 through an electrostatic signal. For example, the communicator 322 may receive pressure information, measured by the contact pressure measurer 312, from the stylus pen 210 of the active electrostatic type through the electrostatic signal.

Further, the communicator 322 may communicate with an external device by using various communication techniques such as Bluetooth communication, Bluetooth Low Energy (BLE) communication, Near Field Communication (NFC), WLAN communication, Zigbee communication, Infrared Data Association (IrDA) communication, Wi-Fi Direct (WFD) communication, Ultra-Wideband (UWB) communication, Ant+ communication, WWI communication, Radio Frequency Identification (RFID) communication, 3G communication, 4G communication, 5G communication, and the like. In this case, the external device may be medical equipment using data used by the electronic device 320, a processing result data of the electronic device 320, or the like, a printer to print out results, or a display to display the results. In addition, the external device may be a digital TV, a desktop computer, a cellular phone, a smartphone, a tablet PC, a laptop computer, a personal digital assistant (PDA), a portable multimedia player (PMP), a navigation, an MP3 player, a digital camera, a wearable device, and the like, but is not limited thereto.

The touch screen 324 may display data used by the electronic device 320, the processing result data of the electronic device 320, and the like. Further, the touch screen 324 may receive input of data by direct or indirect touch of the stylus pen 210. In this case, the touch screen 324 may be implemented as the active electrostatic type.

The sensor 330 may include any one or any combination of a gesture sensor 330a, a face recognition sensor 330b, a gyro sensor 330c, a barometric pressure sensor 330d, an illuminance sensor 330e, an iris recognition sensor 330f, an acceleration sensor 330g, a grip sensor 330h, an UV sensor 330i, and the like.

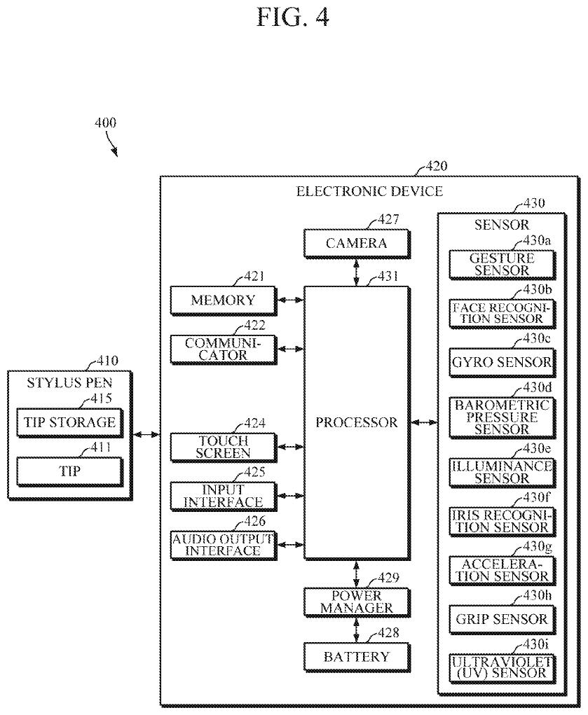

FIG. 4 is a block diagram illustrating an example of a digital copy generating system implemented as a resistive type or a capacitive type. The digital copy generating system 400 of FIG. 4 may be an example of the digital copy generating system 100 of FIG. 1.

Referring to FIG. 4, the digital copy generating system 400 of the resistive type or the capacitive type includes a stylus pen 410 and an electronic device 420.

The stylus pen 410 includes a tip 411 and a tip storage 415. Here, the tip storage 415 may be mounted or provided in the main body 111 of FIG. 1. The tip 411 and the tip storage 415 are the same as the tip 211 and the tip storage 215 of FIG. 2, such that detailed description thereof will be omitted.

The electronic device 420 includes a memory 421, a communicator 422, a touch screen 424, an input interface 425, an audio output interface 426, a camera 427, a battery 428, a power manager 429, a sensor 430, and a processor 431. Here, the memory 421, the input interface 425, the audio output interface 426, the camera 427, the battery 428, the power manager 429, the sensor 430, and the processor 431 are the same as the memory 221, the input interface 225, the audio output interface 226, the camera 227, the battery 228, the power manager 229, the sensor 230, and the processor 231 of FIG. 2, such that detailed description thereof will be omitted.

The communicator 422 may communicate with an external device by using various communication techniques such as Bluetooth communication, Bluetooth Low Energy (BLE) communication, Near Field Communication (NFC), WLAN communication, Zigbee communication, Infrared Data Association (IrDA) communication, Wi-Fi Direct (WFD) communication, Ultra-Wideband (UWB) communication, Ant+ communication, WIFI communication, Radio Frequency Identification (RFID) communication, 3G communication, 4G communication, 5G communication, and the like. In this case, the external device may be medical equipment using data used by the electronic device 320, a processing result data of the electronic device 320, or the like, a printer to print out results, or a display to display the results. In addition, the external device may be a digital TV, a desktop computer, a cellular phone, a smartphone, a tablet PC, a laptop computer, a personal digital assistant (PDA), a portable multimedia player (PMP), a navigation, an MP3 player, a digital camera, a wearable device, and the like, but is not limited thereto.

The touch screen 424 may display data used by the electronic device 420, the processing result data of the electronic device 420, and the like. Further, the touch screen 424 may receive input of data by direct or indirect touch of the stylus pen 210. In this case, the touch screen 324 may be implemented as the resistive type or the capacitive type.

The sensor 430 may include any one or any combination of a gesture sensor 430a, a face recognition sensor 430b, a gyro sensor 430c, a barometric pressure sensor 430d, an illuminance sensor 430e, an iris recognition sensor 430f, an acceleration sensor 430g, a grip sensor 430h, an UV sensor 430i, and the like.

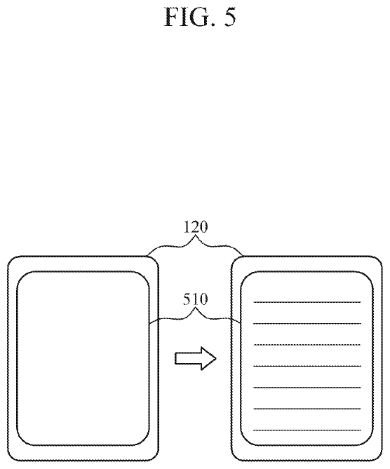

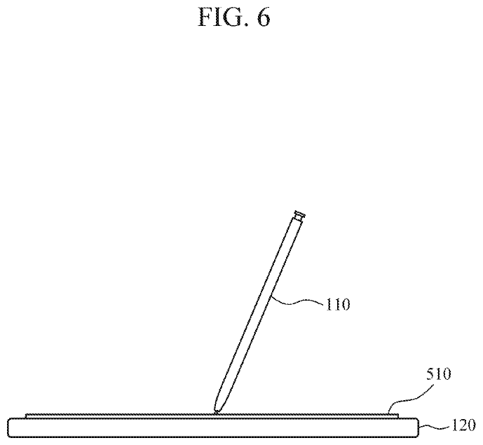

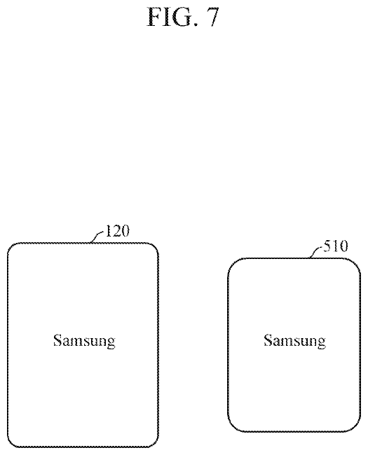

FIGS. 5, 6 and 7 are diagrams explaining an example of a process of generating a digital copy.

Referring to FIGS. 5 to 7, once paper 510 is placed on the full area or a portion of the touch screen of the electronic device 120, the electronic device 120 may automatically execute a note application by sensing the paper 510, and may adjust the brightness of the touch screen so that note lines may be shown through the paper 510.

When a user writes a word “Samsung” on the paper 510 placed on the touch screen of the electronic device 120 by using the stylus pen 110 having a tip made of a material enabling analog writing, the word “Samsung” is written on the touch screen of the electronic device 120 at the same time when the word “Samsung” is written on the paper 510. That is, the electronic device 120 may generate a digital copy corresponding to the word “Samsung” written on the paper 510.

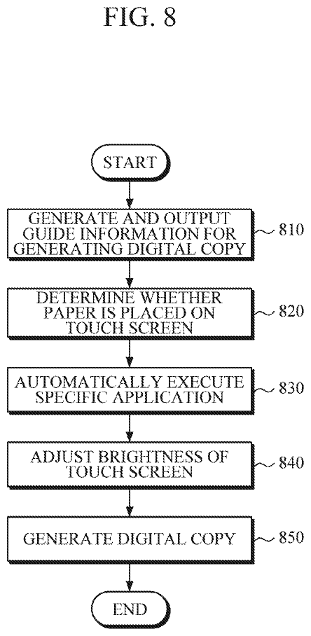

FIG. 8 is a flowchart illustrating an example of a digital copy generating method. The digital copy generating method of FIG. 8 may be performed by the electronic device 120 of FIG. 1.

Referring to FIGS. 1 and 8, in response to occurrence of an event such as a user instruction and the like, the electronic device 120 may generate guide information for analog writing and for generating a digital copy corresponding to the analog writing by using the stylus pen 110, and may provide or output the guide information to a user in operation 810. In this case, the output device may include a visual output device (e.g., touch screen), an acoustic output device (e.g., speaker), a haptic output device (e.g., vibrator), and the like. In one embodiment, the guide information may include information for guiding writing letters or characters or drawing pictures on paper placed on the touch screen by using the stylus pen 110.

The electronic device 120 may determine whether paper is placed on the full area or a portion of the touch screen 224 in operation 820. For example, the electronic device 120 may determine whether the paper is placed on the full area or a portion of the touch screen by using a camera and/or a sensor (e.g., a gesture sensor, an illuminance sensor, etc.).

Upon determining in operation 820 that the paper is placed on the full area or a portion of the touch screen, the electronic device 120 may automatically execute a specific application in operation 830. In this case, examples of the application may include any one or any combination of a note application, a letter tracing application, a drawing application, a picture tracing application, and the like.

The electronic device 120 may adjust brightness of the touch screen so that any one or any combination of note lines, letters, pictures, and the like displayed on the touch screen may be shown through the paper in operation 840.

In addition, when a user writes letters or characters or draws pictures on paper placed on the full area or a portion of the touch screen by using the stylus pen 110, the electronic device 120 may generate a digital copy corresponding to the writing or drawing in operation 850.

Moreover, in one embodiment, in response to a user's instruction or occurrence of an event after a user places paper on the full area or a portion of the touch screen 224, the electronic device 120 may execute an application. In this case, the event may include a touch event and the like by a user's touching an area of the touch screen 224.

The disclosure can be realized as a computer-readable code written on a non-transitory computer-readable recording medium. Codes and code segments for realizing the disclosure can be easily deduced by computer programmers of ordinary skill in the art. The computer-readable recording medium may be any type of recording device in which data is stored in a computer-readable manner. Examples of the computer-readable recording medium include a ROM, a RAM, a CD-ROM, a magnetic tape, a floppy disc, an optical disk, and the like. Further, the computer-readable recording medium can be distributed over a plurality of computer systems connected to a network so that a computer-readable recording medium is written thereto and executed therefrom in a decentralized manner.

The inventive concepts have been described herein with regard to the embodiments. However, it will be obvious to those skilled in the art that various modifications can be made without departing from the gist of the inventive concepts. Therefore, it is to be understood that that the scope of the inventive concepts is not limited to the above-mentioned embodiments, but is intended to include various modifications and equivalents included within the spirit and scope of the appended claims.

What is claimed is:

1. A stylus pen comprising:
a main body; and
a tip disposed on the main body, and comprising a material enabling analog writing.

2. The stylus pen of claim 1, wherein the tip comprises either one or both of a metal-oxide alloy and a graphite-containing polymer.

3. The stylus pen of claim 1, wherein the tip has different colors to indicate a replacement time of the tip.

4. The stylus pen of claim 3, wherein the tip is divided into a first portion of a first color and a second portion of a second color, and
wherein the second portion is worn out after the first portion is worn out.

5. The stylus pen of claim 1, wherein the main body comprises a tip storage for storing another tip.

6. An electronic device comprising:
a touch screen; and
a processor configured to:
determine whether a paper is placed on the touch screen; and
based on the paper being determined to be placed on the touch screen:
execute an application; and
based on letters or characters being written on the paper or a picture being drawn on the paper, using a stylus pen comprising a material enabling analog writing, generate a digital copy of the letters, the characters or the picture.

7. The electronic device of claim 6, wherein the touch screen is of any one or any combination of an electromagnetic resonance type, an active electrostatic type, a resistive type, and a capacitive type.

8. The electronic device of claim 6, wherein the application is any one or any combination of a note application, a letter tracing application, a drawing application, and a picture tracing application.

9. The electronic device of claim 6, wherein the processor is further configured to, based on an occurrence of an event, generate guide information for the analog writing and for generating the digital copy.

10. The electronic device of claim 6, wherein the processor is further configured to determine whether the paper is placed on a full area or a portion of the touch screen, using either one or both of a camera and a sensor.

11. The electronic device of claim 6, wherein the processor is further configured to adjust a brightness of the touch screen so that any one or any combination of a note line, a word, and a picture that is displayed on the touch screen based on the application being executed, is shown through the paper.

12. A digital copy generating method of an electronic device, the method comprising:
determining whether a paper is placed on a touch screen; and
based on the paper being determined to be placed on the touch screen:
executing an application; and
based on words or characters being written on the paper or a picture being drawn on the paper, using a stylus pen comprising a material enabling analog writing, generating a digital copy of the words, the characters or the picture.

13. The method of claim 12, wherein the application is any one or any combination of a note application, a letter tracing application, a drawing application, and a picture tracing application.

14. The method of claim 12, further comprising, based on an occurrence of an event, generating guide information for the analog writing and for generating the digital copy.

15. The method of claim 12, further comprising determining whether the paper is placed on a full area or a portion of the touch screen, using either one or both of a camera and a sensor.

16. The method of claim 12, further comprising adjusting a brightness of the touch screen so that any one or any combination of a note line, a word, and a picture that is displayed on the touch screen based on the application being executed, is shown through the paper.
